(19) United States
(12) Patent Application Publication
(10) Pub. No.: US 2019/0345827 A1
(43) Pub. Date: Nov. 14, 2019

(54) RUNNER FOR A HYDRAULIC TURBINE OR PUMP

(71) Applicant: Voith Patent GmbH, Heidenheim (DE)

(72) Inventors: Kenneth Dunbar, Manchester, PA (US); Daniel Mc Ginnis, Hanover, PA (US); John Seifarth, York, PA (US); Benjamin Kotzman, New Oxford, PA (US)

(73) Assignee: Voith Patent GmbH, Heidenheim (DE)

(21) Appl. No.: 16/520,941

(22) Filed: Jul. 24, 2019

Related U.S. Application Data
(63) Continuation of application No. PCT/EP2017/081658, filed on Dec. 6, 2017.
(60) Provisional application No. 62/449,835, filed on Jan. 24, 2017.

(51) Int. Cl. F01D 5/14; F03B 3/02

(52) U.S. Cl. CPC F01D 5/147; F03B 3/02

(57) ABSTRACT

A runner for a hydraulic turbine or pump, including a plurality of plurality of blades, each blade being defined by a pressure surface, an oppositely facing suction surface, a leading edge and a spaced apart trailing edge, at least one of the plurality of blades having a gas inlet aperture and a gas passage for supplying a flow of oxygen containing gas to the trailing edge of the same blade. The same blade also includes a continuous opening in the trailing edge to admit gas out of the gas passage to the passing fluid during operation of the runner. The continuous opening extends over at least 15% of the developed length of the trailing edge.

### CROSS REFERENCE TO RELATED APPLICATIONS

This is a continuation of PCT application No. PCT/EP2017/081659, entitled “RUNNER FOR A HYDRAULIC TURBINE OR PUMP”, filed Dec. 6, 2017, which is incorporated herein by reference.

### BACKGROUND OF THE INVENTION

### 1. Field of the Invention

The present invention relates generally to hydroelectric turbine or pump installations. More particularly, this invention pertains to hydroelectric installations with ways for enhancing the level of dissolved gas in water passing through the turbine or pump.

### 2. Description of the Related Art

A significant environmental problem for many hydroelectric facilities is the water quality of discharges. Various attempts have been made to enhance the level of dissolved oxygen in discharged water of hydroelectric installations. For example, U.S. Pat. No. 5,924,842 to Beyer, James R. discloses a runner for a Francis turbine comprising a crown; a band substantially concentric with the crown; and a plurality of blades extending between crown and the band at spaced intervals along the crown, each blade fixedly secured to the crown at an inner edge and to the band at a distal outer edge, each blade having a water directing surface defined by a pressure side, an opposite facing suction side, a leading edge and a spaced apart trailing edge, at least one of the blades including: a leading edge blade portion having a rear edge in which a first slot is machined along at least a portion of the rear edge; a trailing portion having a front edge in which a second slot is machined along at least a portion of the front edge; wherein the trailing portion is fixedly secured to the leading blade portion along the front edge and the rear edge, respectively, so that the first and second channels cooperate to form an integral passage in the at least one of the blades; and means for discharging an oxygen containing gas from the integral passage to a location adjacent the trailing edge. These means include a plurality of discharge passages extending from the integral passage to the trailing edge.

Known installations attempt to increase the level of dissolved oxygen downstream of the turbine or pump by introducing an oxygen containing gas into the water passing through the unit.

What is needed in the art is an installation to increase the level of dissolved oxygen downstream of the turbine or pump.

### SUMMARY OF THE INVENTION

The present invention provides a runner of a hydraulic turbine or pump, which is capable of dissolving more oxygen than the runners according to known installations.

The present invention also provides a runner for a hydraulic turbine or pump. The runner includes a plurality of blades. Each blade of the plurality of blades is defined by a pressure surface, an oppositely facing suction surface, a leading edge and a spaced apart trailing edge. At least one blade of the plurality of blades includes a gas inlet aperture and a gas passage for supplying a flow of oxygen containing gas to the trailing edge of the at least one blade. The at least one blade including a continuous opening in the trailing edge to admit gas out of the gas passage to a passing fluid during operation of the runner. The continuous opening extends over at least 15% of a developed length of the trailing edge.

The amount of oxygen containing gas flowing towards the trailing edge may depend on the difference between the pressure at the inlet of the gas passage (normally atmospheric pressure) and the pressure at the trailing edge. However any obstacle to the gas flow located in the gas passage between these two locations will cause a pressure drop and therefore decrease the gas flow and thus the amount of dissolved oxygen. The main obstacle to the gas flow of the prior art may be the plurality of discharge passages each of them consisting in a narrow channel towards the trailing edge. This leads to a sub optimal gas flow and thus to a sub optimal amount of dissolved oxygen in the prior art.

The plurality of narrow discharge passages may be replaced by a continuous opening at the trailing edge that extends over at least 15% of the developed length of the trailing edge.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a cross-sectional view of an axial turbine runner according to FIG. 25 of U.S. Pat. No. 5,924,842;

FIG. 2 is a cross-sectional view of a runner blade according to an embodiment of the present invention;

FIG. 3A shows a cross-sectional view of the runner blade of FIG. 2, taken across line 3A-3A;

FIG. 3B shows different kinds of embodiments of a cross-section view of the runner blade of FIG. 2, taken across line 3B-3B;

FIG. 4 is a cross-sectional view of a runner blade according to another embodiment of the present invention;

FIG. 5 shows a cross-sectional view of the runner blade of FIG. 4, taken along line 5-5;

FIG. 6 is a cross-sectional view of a runner blade according to another embodiment of the present invention;

FIG. 7 is a cross-sectional view of a Francis turbine runner according to the present invention; and

FIG. 8 is a cross-sectional view of an axial turbine runner according to the present invention.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

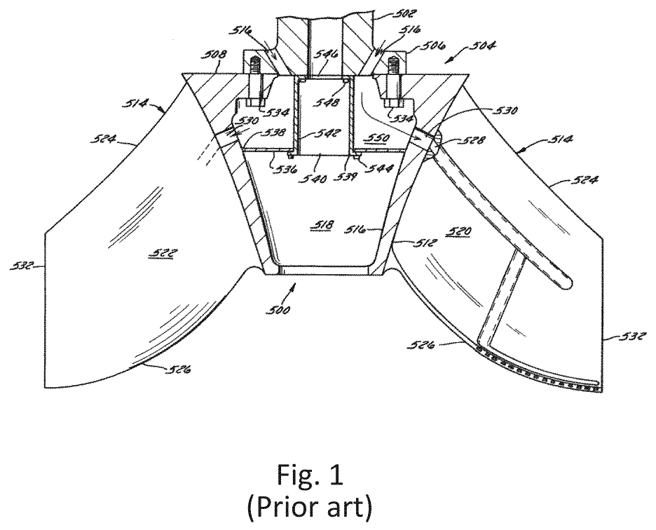

FIG. 1 displays a runner according to the prior art (FIG. 25 of U.S. Pat. No. 5,924,842). Clearly visible is the plurality of the narrow discharge passages located at the trailing edge which is designated as 526.

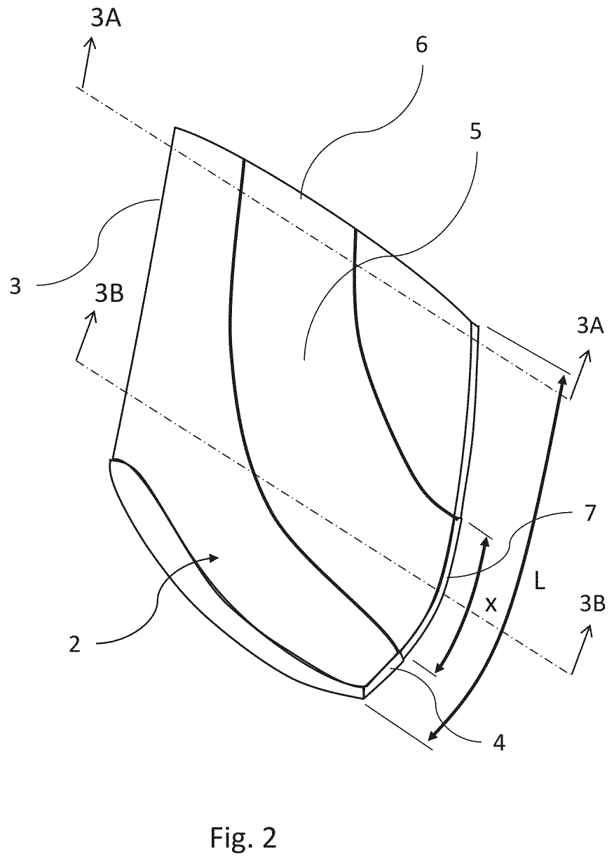

FIG. 2 displays schematically a cross-sectional view of a runner blade 2 according to present invention. The blade 2 has a leading edge 3 and a trailing edge 4 meaning that the fluid entering the runner flows from the leading edge 3 towards the trailing edge 4. The fluid flow is divided by the blade 2 whereas one side of the blade 2 forms the pressure surface and the other side the suction surface. The blade 2 shown in FIG. 2 contains a gas passage which is designated as 5. The blade 2 has a gas inlet apertures designated as 6. At the trailing edge 4, there is a continuous opening 7. The continuous opening 7 extends over at least 15% of the developed length of the trailing edge 4 (x/L>=0.15). The gas passage 5 is capable of delivering oxygen containing gas from the gas inlet aperture 6 to the continuous opening 7. The gas flowing in through the gas inlet apertures 6 is admitted through the continuous opening 7 within the trailing edge 4 into the fluid i.e. water passing the trailing edge 4. Inlet aperture 6, gas passage 5 and the continuous opening 7 are forming a smooth passage through the blade minimizing pressure losses as the gas flows through the blade. This results in increased levels of dissolved oxygen in the water passing the trailing edge 4.

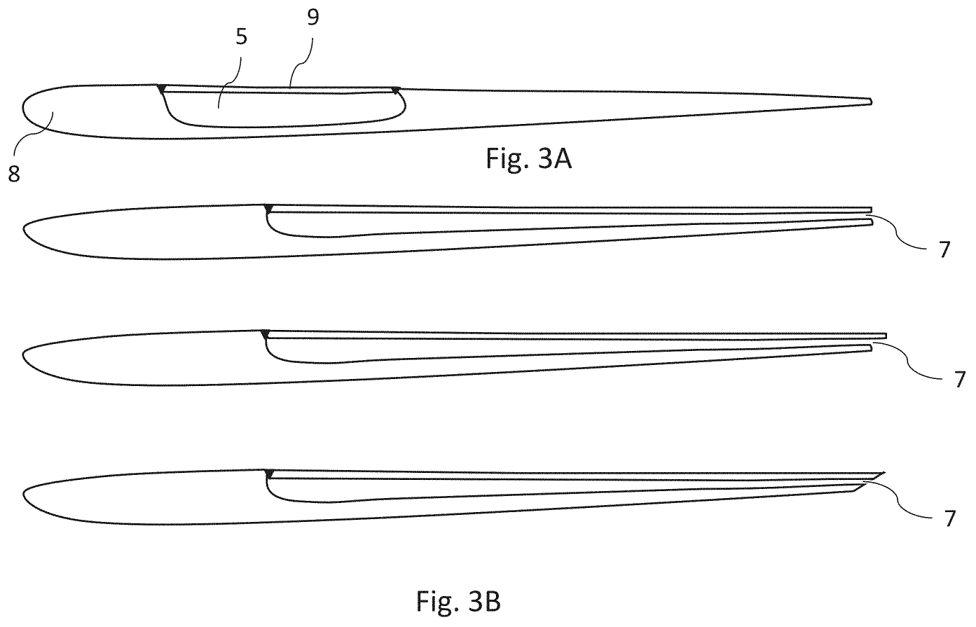

FIGS. 3A-3B display schematically cross-sectional views through the blade 2 of FIG. 2 along the marked sections 3A-3A and 3B-3B. FIG. 3B displays three different embodiments of the continuous opening 7 which is displayed in three different views along the cross-section. In the view along section 3A-3A it can be seen that the blade 2 includes a base part which is designated by 8 and a cover part 9. The base part 8 includes either the entire suction side or pressure side surface as well as the entire leading edge surface and a substantial portion of the trailing edge surface. A cavity is machined or cast into the base part 8. The thinner cover part 9 is attached to the base part 5 thus forming the gas passage 5. The cover part 9 may be metal or composite material, may be cast formed or machined and may be attached by welding or by a bonding material (epoxy, glue, etc.). The topmost cross-sectional view along section 3B-3B shows a first embodiment of the continuous opening 7. The continuous opening 7 is confined by the pressure and suction side surfaces which meet at the trailing edge 4. In this first embodiment the pressure and suction side surfaces are ending respectively at the same distance measured from the leading edge 3 along the section's camberline. The middle cross-sectional view along section 3B-3B shows a second embodiment of the continuous opening 7. In this second embodiment the pressure side surface extends further than the suction side surface measured from the leading edge 3 along the section's camberline. The bottom cross-sectional view along section 3B-3B shows a third embodiment of the continuous opening 7. In the third embodiment the trailing edge 4 in the region of opening 7 is profiled to minimize vortex shedding. Of course this kind of profile can be present over the whole length of the trailing edge 4.

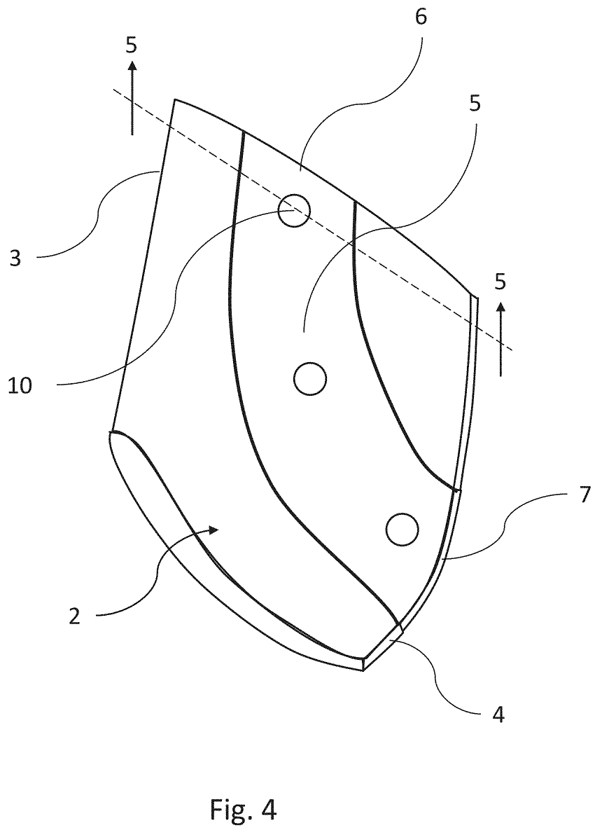

FIG. 4 displays schematically a cross-sectional view of a runner blade according to present invention in another embodiment. Additionally to the blade of FIG. 2 the embodiment according FIG. 4 includes three spacer pieces one of them being designated as 10.

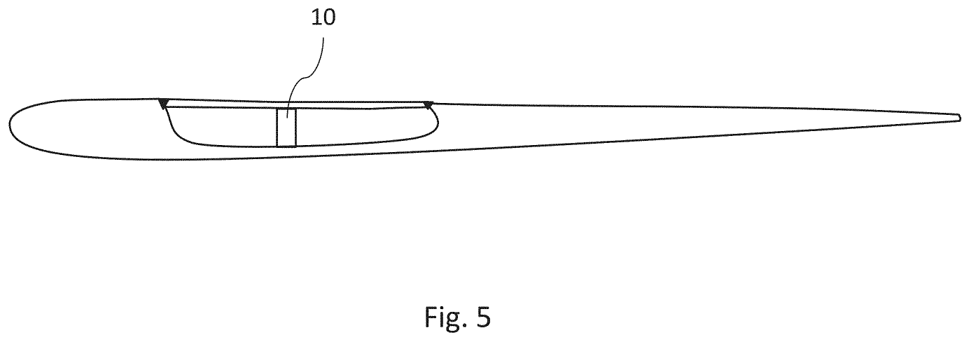

FIG. 5 shows a cross-sectional view along cross-section 5-5 displaying a side view of the spacer piece 10. Spacer pieces 10 are positioned within the gas passage 5 as needed to avoid the buckling of the cover part 9. The spacer pieces 10 could be integral to the base part 8 or fixedly attached to either the base part 8 or cover part 9. The number of spacer pieces 10 may not be restricted to the number of three but there can be any number of spacer pieces 10.

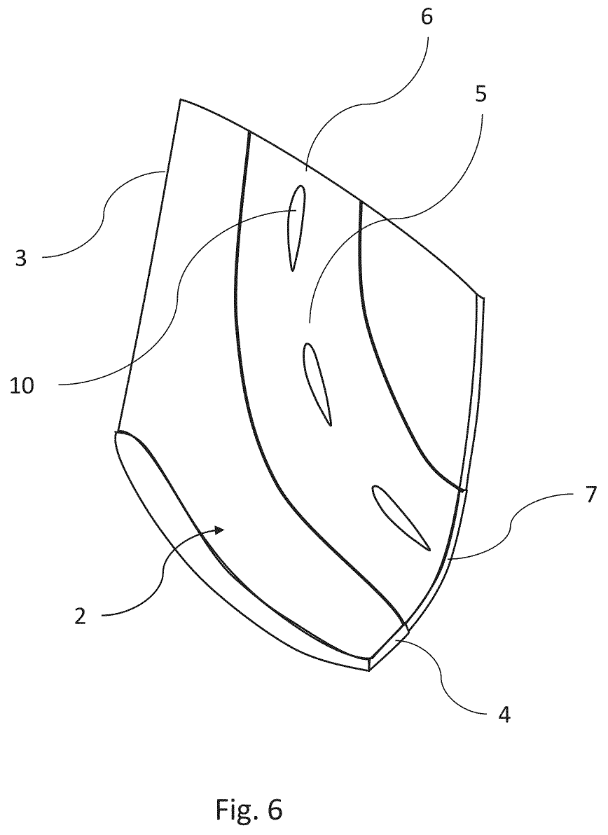

The inventors have realized that the spacer pieces 10 are forming an obstacle to the gas flow. Therefore, it is favorable that the spacer pieces are of aerodynamic shape. FIG. 6 shows the runner according to the present invention featuring aerodynamically shaped spacer pieces 10.

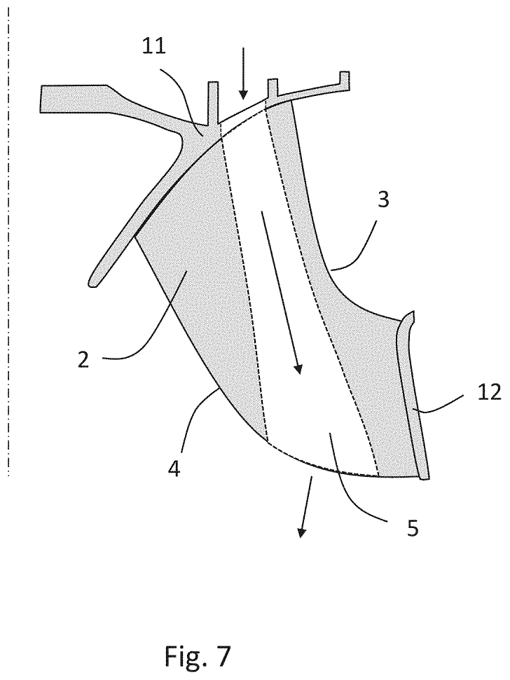

FIG. 7 displays schematically a cross-sectional view of a Francis turbine runner according to the present invention. The runner crown is designated as 11. A runner blade 2 extends between the crown 11 and the band designated as 12. The gas inlet aperture 6 is located in the runner crown 11. The arrows are indicating the gas flow. Gas passage, leading and trailing edge are designated as usually.

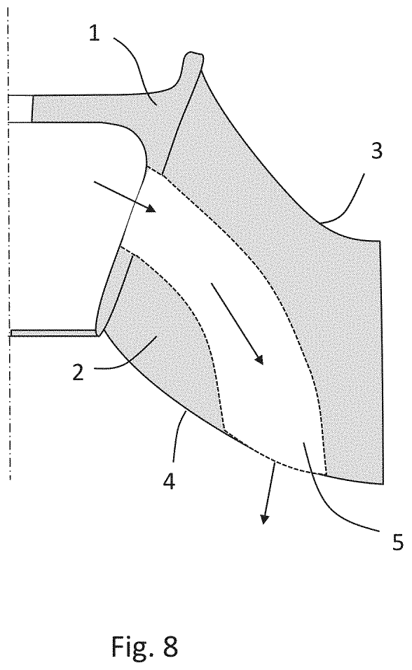

FIG. 8 displays schematically a cross-sectional view of an axial flow turbine runner according to the present invention. A runner blade 2 extends radially from a runner hub 1. The gas inlet aperture 6 is located in the runner hub 1. The arrows are indicating the gas flow. Gas passage, leading and trailing edge are designated as usually.

It should be appreciated that the embodiments shown in the figures are examples of a much broader variety of embodiments each employing the inventive ideas. For example, there could be several separate gas passages through one blade leading from separate gas inlet apertures to several separate continuous openings located at different portions of the trailing edge. Or a gas inlet could be located in the band of a Francis turbine.

The present invention is also not restricted to turbines and pumps of the Francis type, or fixed blade axial turbines and pumps, but extends also to axial flow Kaplan turbines and pumps of the Kaplan type.

In principle any oxygen containing gas can be used, for instance air or pure oxygen.

Finally, it is noted that the present invention is not only capable of increasing the amount of dissolved oxygen in a higher magnitude compared with the prior art, but saves also manufacturing costs. According to the invention, the blade is constructed from only two main parts. This simplifies the construction by minimizing the number of surfaces to be joined. The gas passage at trailing edge is the result of locally spacing apart the cover part and base part. This eliminates the need for, and complexity of many small gas passages in the trailing edge.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A runner for a hydraulic turbine or pump, comprising:
a plurality of blades, each blade of the plurality of blades being defined by a pressure surface, an oppositely facing suction surface, a leading edge and a spaced apart trailing edge, and at least one blade of the plurality of blades includes a gas inlet aperture and a gas passage for supplying a flow of oxygen containing gas to the trailing edge of the at least one blade, and the at least one blade including a continuous opening in the trailing edge to admit gas out of the gas passage to a passing fluid during operation of the runner, and the continuous opening extends over at least 15% of a developed length of the trailing edge.

2. The runner of claim 1, wherein the runner is an axial flow runner, comprising a hub and wherein the plurality of blades extend from the hub at circumferentially spaced intervals.

3. The runner of claim 1, wherein the runner is a Francis turbine, comprising a crown and a band, and wherein the plurality of blades extend from the crown to the band at circumferentially spaced intervals.

4. The runner of claim 3, further including a gas inlet aperture that is located within the crown.

5. The runner of claim 3, further including a gas inlet aperture that is located within the band.

6. The runner of claim 2, further including a gas inlet aperture that is located within the hub.

7. The runner of claim 1, wherein in a region of the continuous opening, the pressure surface extends further than the suction surface measured from the leading edge along a camberline of the runner.

8. The runner of claim 1, wherein the at least one blade having the gas passage further includes a base part and a cover part, wherein the base part is of a single piece construction including the entire leading edge, the entire pressure surface, as well as a portion of the trailing edge surface, and wherein the base part contains a cavity and the cover part is attached to the base part above the cavity to form the gas passage.

9. The runner of claim 1, wherein the at least one blade having the gas passage further includes a base part and a cover part, wherein the base part is of a single piece construction including the entire leading edge, the entire suction surface, as well as a portion of the trailing edge surface, and wherein the base part contains a cavity and the cover part is attached to the base part above the cavity to form the gas passage.

10. The runner of claim 9, further comprising at least one spacer piece that is located between the base part and the cover part within the gas passage.
